(19) United States
(12) Patent Application Publication
(10) Pub. No.: US 2014/0136370 A1
(43) Pub. Date: May 15, 2014

(54) System and Method for Optimization of Lease Management and Operation

(71) Applicants: Karen A. Gladney, Lone Tree, CO (US); Ian Andrews, Denver, CO (US)

(72) Inventors: Karen A. Gladney, Lone Tree, CO (US); Ian Andrews, Denver, CO (US)

(73) Assignee: Power Leasing Systems, Inc.

(21) Appl. No.: 13/862,404

(22) Filed: Apr. 13, 2013

Related U.S. Application Data
(60) Provisional application No. 61/623,810, filed on Apr. 13, 2012.

(51) Int. Cl. G06Q 30/06; G06Q 50/16

(52) U.S. Cl. CPC G06Q 30/0617; G06Q 50/163
USPC 705/26.43

(57) ABSTRACT

The present invention concerns a system and method that includes use of a mobile computing device having a visual display and means to run a software application installed on it that includes a front-end interface that provides a step-by-step tool to both collect information from a prospective renter, an algorithm for optimizing available property selection using the information collected by the prospect, and presentation of media and information about the property and neighborhood to the prospect in an integrated way. The application further includes communications functionality that allow communications with a data cloud that both delivers appropriate media for display by the application as well as storage of any information collected from the prospect via the application. The system then uses the information to generate reports and provide analytics to prospects, leasing agents, leasing managers and building owners based on the information most relevant and important to them.

### PRIORITY CLAIM

This application claims the benefit of U.S. provisional patent application No. 61/623,810, filed Apr. 13, 2012.

### BACKGROUND OF THE INVENTION

The field of real estate leasing and management has been largely static over the past twenty years. In the traditional scenario, a prospect would come to an apartment building or management company, complete a paper form along with a copy of an identification card, and then would be escorted to see one or more available units. If the prospect is not interested in that particular unit, then the tour is over and the prospect goes to a new apartment building or management company. If the prospect is interested in a unit following the tour, and the leasing agent is complying with the traditional process, they would then take the paper form and enter one or more fields of data into a proprietary customer relationship software. This may also lead to one or more follow-ups, which are often reminders scribbled on sticky notes or paper calendars.

The existing process is deficient for a number of reasons. First and foremost, the use of paper files and forms creates unnecessary waste and redundancy. The time it takes to enter the same data into the system is an inefficient use of agent time. The data could be mistyped or other errors introduced in the process, and of course the process can often lead to a lack of follow-up as some agents are not always on top of the process or for whatever reason may decide that prospect was not promising. In other words, it is both time-consuming and also inconsistent as much depends on the quality and training of the leasing associate.

Another deficiency is that the information collected is often very general information and does not necessarily tell the management company or apartment building why the prospect was not interested, what features were the features that either interested them or turned them off, and there is little ability for the apartment building or management company to effectively track their visits with any certainty or reliability. In other words, the process is slow, unreliable and lacks effective business informatics.

Finally, because so much of the current information is in paper form—or if it is electronic, is fragmented in multiple databases and disassociated—it is difficult to use this important data for follow-on opportunities. Opportunities such as marketing special services to move-ins, using their Facebook® or social media data to predict likely servicers they would need, and/or contact information to run those promotions outside of the normal “welcome to the neighborhood” collection of paper coupons, menus and other promotional prices that are given to each and every person without regard to their unique attributes, demographics or social circles.

What is needed, then, is a system that can guide an agent through an effective business process, in a smooth and reliable way, that enables direct entry and collection of data in a manner that is both intuitive, real-time and meets the business and informational needs of the owner, the agency, the prospect and the agent. What is further needed is a reporting and analytics engine that can take each of these data points and, following a move in, can be used to optimize the offers, promotions, coupons and other features that can be offered to a prospect or new resident in a personalize and therefore, more effective way.

### SUMMARY OF THE INVENTION

The present invention provides a system and method that comprises three components. The first component is a front end interface (“FEI”) that provides a comprehensive series of steps that can be performed by a leasing agent in conjunction with a prospect that serves the purpose of both collecting information about the prospect (providing “narrowing” questions that help pinpoint the ideal unit for the prospect and their desired features) and providing an engaging way for the property management to highlight applicable features and related media. This FEI could reside on any sort of device that includes a processing unit, digital memory and a display but for the purposes of our description and the preferred embodiment would be on a tablet or similar mobile device such as an Apple iPad®.

The second component is a data collection and retrieval engine (“Data Cloud”). The Data Cloud includes one or more databases that set forth the unique characteristics, media, features sets and other related information for a given property. The Data Cloud could further include customizations or related instructions for the FEI such as the ordering of certain questions, special questions or queries that would be included in the FEI for use during a prospect interview or any number of other media (photographs, videos, social media links, maps) that could either be retrieved by the FEI from the Data Cloud or just links to that information (whether available on a public or private network, such as the Internet) that should be retrieved in response to one or more actions performed on the FEI.

The Data Cloud could optionally further include the capability to receive information from the FEI regarding the prospect, feedback on the property, answers to surveys and other data that may have been disclosed by the prospect to the agent and submitted via the FEI. It is well understood that these capabilities can be performed using databases or similar data storage and retrieval means.

The third component is the reporting and Analytics Engine (“Analytics Engine”) that retrieves one or more fields of information collected from prospects and stored in the Data Cloud, and performs operations on the data in order to ascertain important metrics such as prospect interest in features of the property, future upgrades, pricing sensitivity and other information that can more effectively help a leasing agency, building management or owners optimize their management and/or investment decisions as it relates to real estate.

### BRIEF DESCRIPTION OF THE DRAWINGS

FIG. 1 shows a block diagram illustrating one or more components of one sample embodiment used to perform the present invention.

FIG. 2 provides a block diagram illustrating one or more components of the Front End Interface 100.

FIG. 3 is a screenshot showing a sample Front End Interface 100.

FIG. 4 is a block diagram illustrating the key components of the Data Cloud 200 of the present invention.

FIG. 4 is a block diagram illustrating sub components of the Analytics Engine 300.

FIG. 5 is a flowchart illustrating the method of using the present invention to interview a prospect.

FIG. 6 is a block diagram illustrating components of the Reporting Engine.

FIG. 7 is a sample report reflecting one embodiment of an output that could be generated by the Analytics Engine.

### DETAILED DESCRIPTION OF EXAMPLE EMBODIMENTS

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. For example, when we describe the Data Cloud, it will be evident that the Data Cloud is not one thing but a group of things that can speak to each other. Similarly, where more than one device or article is described (whether or not they cooperate), it will be readily apparent that a single device/article may be used in place of the more than one device or article. For example, the Analytics Engine could be integrated or a feature of the Data Cloud.

One or more other devices that are not explicitly described as having such functionality/features may alternatively embody the functionality and/or the features of a device. Thus, other embodiments of one or more of the invention(s) need not include the device itself.

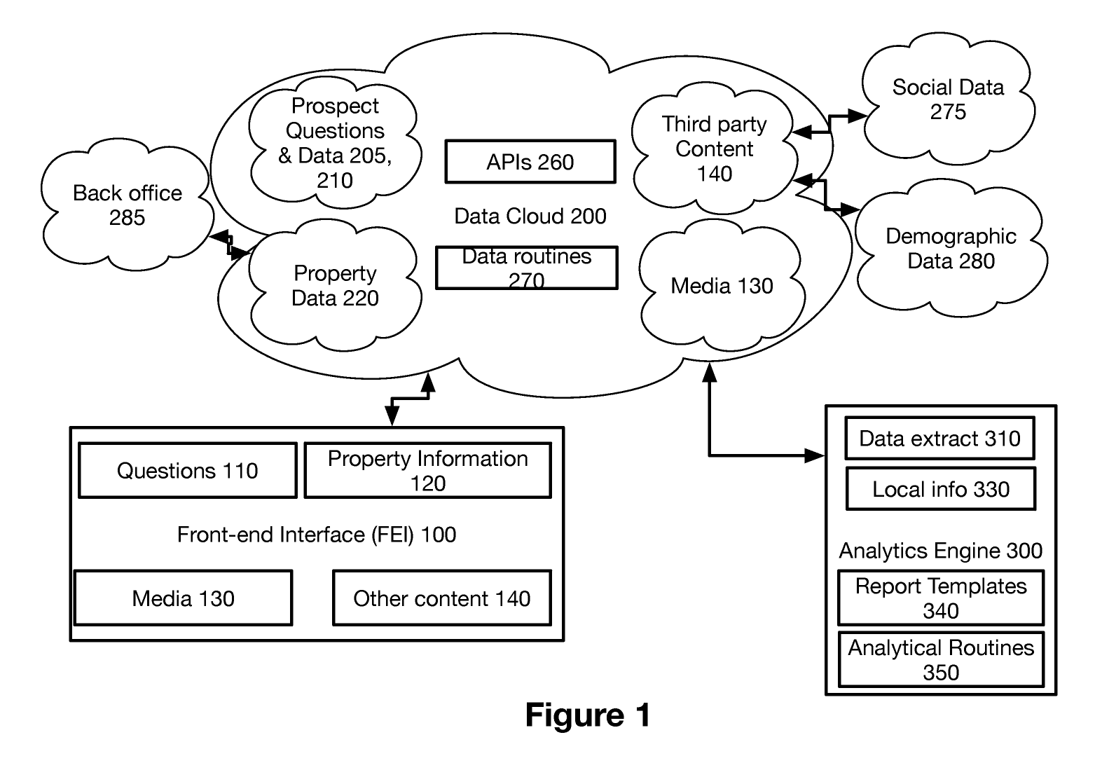

Referring now to FIG. 1, a block diagram illustrating key components of the present invention is shown. More specifically, the components include the FEI 100, the Data Cloud 200 and the Analytics Engine 300.

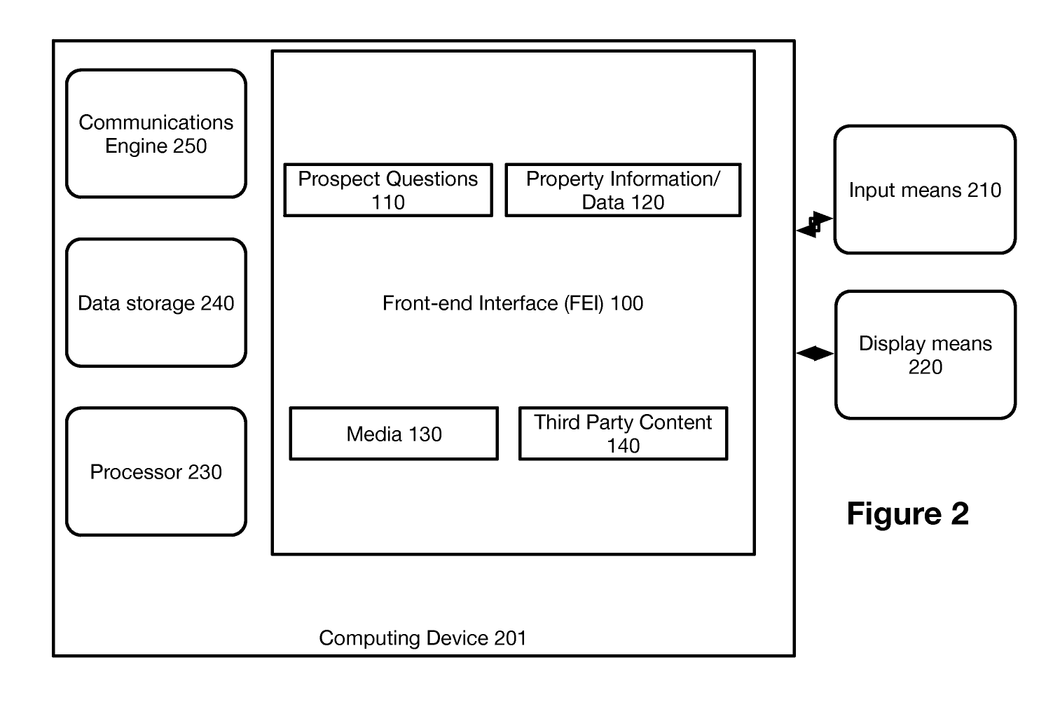

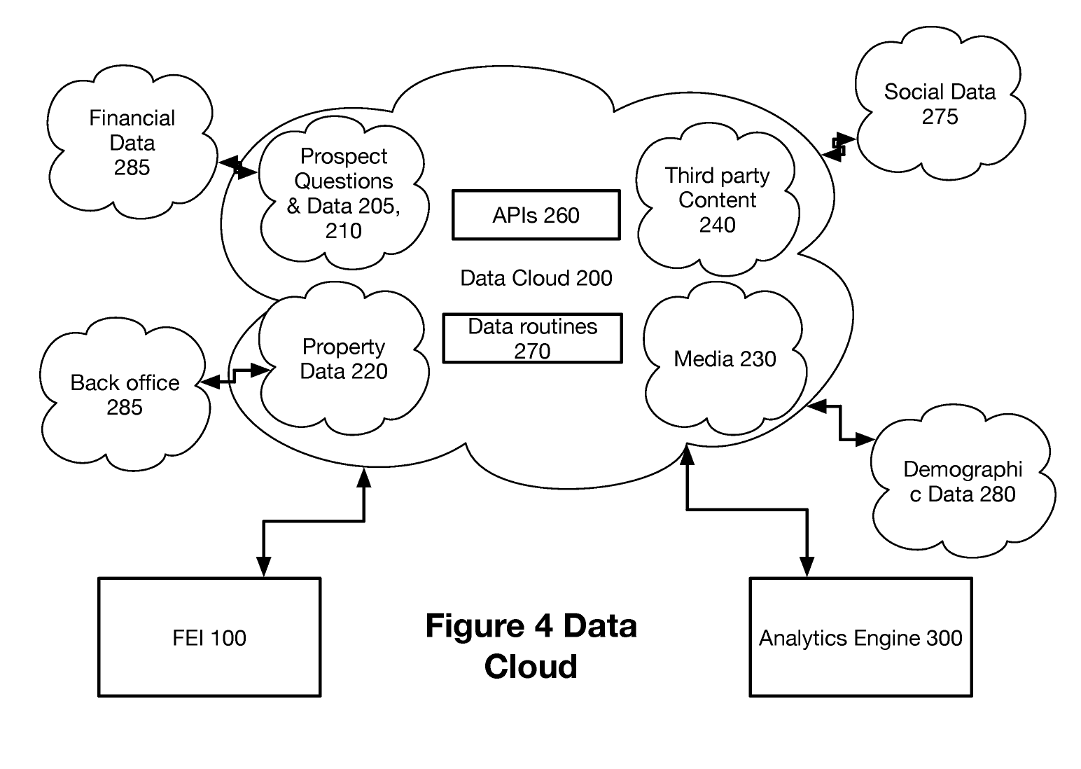

The first component is FEI 100, which is mostly commonly implemented in the form of a software application. Referring now to FIG. 2, the FEI 100 is itself composed of four subcomponents: Prospect Questions 110, Property Information 120, Media 130, and Third Party Content 140. In the preferred embodiment, each of these are integrated into the FEI 100 to form a seamless experience as a prospect is taken through a process by a leasing agent using a combination of questions to solicit Prospect Data 210 (see FIG. 4) that help solicit preferences and unit availability while also giving important Media 130 and Third Party Content 140 that can stimulate interest in the property.

In the preferred embodiment, the FEI 100 integrates Questions 110, Information 120, Media 130 and Content 140 and is executed by a touch driven interface in a software application. It is configured to set out a comprehensive series of steps that can be performed by a leasing agent in conjunction with a prospect. This provides both a logical and optimal way of making the prospect comfortable and yet also moving toward a desired outcome i.e. finding (or not finding) a unit that might be ideal for the prospect. This is done in part by using “strategic narrowing” questions 110 that help pinpoint the ideal unit for the prospect and their desired features. Some of these questions 110 could be framed as objective questions 110 such as “how many children do you have?” These sorts of questions 110 could be used to eliminate choices that are clearly not supported—such as eliminating a one-bedroom unit for a six-person family. Other questions 110 could be framed more subjectively, such as asking the prospect to prioritize a list of features that the prospect would like to see in an apartment.

As the prospect (or leasing agent on behalf of the prospect) completes the process of entering data 210 in the FEI 100, the FEI 100 also supports the transition from interested prospect to applicant by pre-populating common questions 110 needed by forms, such as leasing applications. In other words, as the prospect gets more interested in a unit, the leasing agent or prospect could indicate a preference to apply and the FEI 100 could then take all Prospect Data 210 collected so far and request one or more additional questions 110 to be answered in order to complete that additional step.

Property Information 120 is the second subcomponent of the FEI 100. Property Information 120 includes any objective or subjective information about the property and could include anything from number of rooms, bathrooms, features, location, and other salient aspects of the property that are commonly used and published in connection with leasing or selling real estate. The Property Information 120 could be pre-populated in the FEI 100, manually entered or could instead be retrieved from the Data Cloud 200 whenever the FEI 100 is initiated or being used.

Media 130 is much like Property Information 110 and can either be pre-populated in the FEI 100 or retrieved from the Data Cloud 300. Media 130 can include any number of multimedia files such as pictures, videos, sound files or other files that can illustrate the property, neighborhood, city or other media that might be helpful to a prospect.

Third Party Content 140 is content that could be retrieved by the FEI from a sub component Data Cloud 300, such as Social Data 275, Demographic Data 280 and similar data available on a network (such as the Internet). In one example embodiment, the FEI could retrieve information about local schools (such as Greatschools.org) or information about local nightlife and entertainment (such as a Walkability™ score). Once again, these can be retrieved in real-time from the Data Cloud 200, from a network such as the Internet (not shown) or directly entered into the FEI 100 during configuration of the FEI.

In terms of running the FEI 100, the FEI 100 can reside on any sort of device that includes a processor 230, digital memory or storage 240, means for input 210 (such as a touch screen or keyboard and mouse), access to a network via a communications engine 250 such as a wireless chip or other communications technology and a means for displaying 220 text and images. In the preferred embodiment, the FEI 100 would be run on a tablet or similar mobile device such as an Apple iPad®, Windows® or Android® based tablet or mobile device in which the input means 210, display means 220, communications engine 250, data storage 240 and processor 230 are integrated into a single, mobile device.

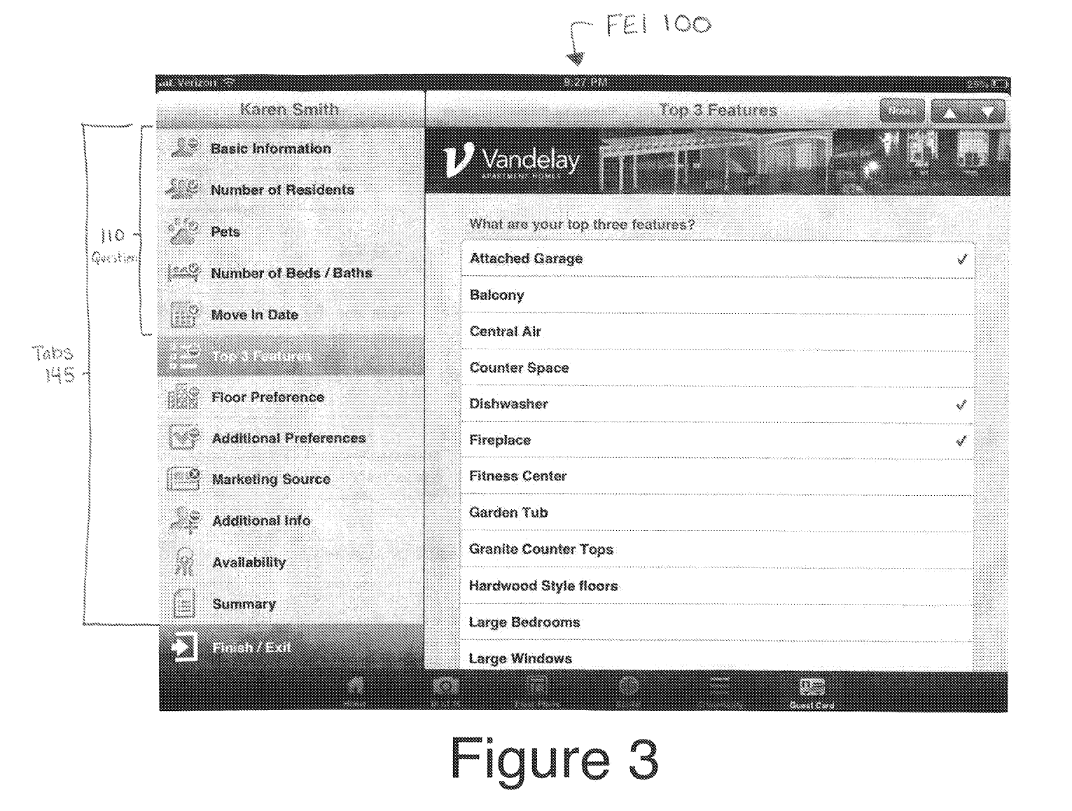

Referring now to FIG. 3, a sample screenshot of an FEI 100 of the software program is shown. In this embodiment, the FEI 100 is controlled using touch-based technology and includes tabs 145 along the side that enable a prospect or leasing agent to skip among and between questions. In the preferred embodiment, the prospect or leasing agent would need to walk through each tab in order in order to optimize the use of “strategic narrowing” questions 110 and to secure the maximum amount of Prospect Data 220. Furthermore, a tab would only be available once a question or input required by that tab 145 is complete. By having control over which tabs 145 can be accessed and what conditions must exist before a tab 145 is available, the FEI provides a step-by-step optimization of the process that is both logical and optimized to maximize prospect interest in the property. The software application that powers the FEI could be a native apple iOS® application or other operating platform or could alternatively be powered by a browser, such as Microsoft® Internet Explorer®, Firefox, Google® Chrome® or Apple® Safari®.

The second component shown in FIG. 1 is the Data Cloud 200. Referring now to FIG. 4, a block diagram setting forth the subcomponent of the Data Cloud 200 is shown. The Data Cloud 200 provides access to any information that is required by the FEI 100 or is otherwise entered by a prospect or agent using the FEI 100. For example, Prospect Data 210 is information that has been submitted in response to one or more Prospect Questions 110. As was noted with reference to FIG. 1, Prospect Questions 110 could either be coded into the FEI 110 or could be retrieved from the Data Cloud dynamically by storing one or more Prospect Questions 205 that could then be retrieved and used to either replace or supplement the Prospect Questions 110 already in the FEI. This has several advantages including by enabling a leasing agency to update the Prospect Questions 205 in the Data Cloud 200 and automatically having those new questions 205 instantiated into the FEI 100 without further coding or FEI 100 modification. Again, as answers to Prospect Questions 110 are entered via the FEI 100, Prospect Data 210 would be updated to reflect those answers. Prospect Data could further include information not entered via the FEI but later added or attached to the prospect such as follow-up dates, credit scores, financial data, publicly available social media data 285, demographic data 280 or any number of other attributes that are later appended to the Prospect Data 210.

Similarly, Property Data/Information 220 can be stored in the Data Cloud 200 in order to permit real-time updates and modifications to the Property Information 120 as set forth in the FEI 100 whenever the FEI has access to the Data Cloud 200. This is especially important for Property Information 220 that is likely to change regularly, such as rental amounts, availability, and, during upgrades or remodels, the features of the respective units that are being managed by the leasing agency.

The final subcomponent illustrated in FIG. 4 is Media 230. Media 230 includes any images, files, logos, videos (such as YouTube®), three dimensional walk-throughs or other content that can be used in conjunction with the FEI 100 including media 130 and Third Party Content 140, 240 that is or could be stored in the FEI 100.

The Data Cloud 200 is illustrated as a single integrated item but in practice the Data Cloud 200 could be comprised of several different computer servers, either at one location or at multiple locations (virtual servers or real), and servers that are publicly available and servers that are only privately available. For example, if a leasing agency has a back office system that includes property information 220, the Data Cloud 200 could include such servers or could instead extract or export data from the back office system for placement on an alternative server that is in the Data Cloud. Similarly, Media 230 could include video content, such as a virtual walk-through, that has been posted to a publicly available third party server such as YouTube®. Again, the media could be retrieved and stored on a specific server in the Data Cloud 200, could instead be retrieved in real-time from the YouTube® server or could even be directly stored in the FEI with media 130 depending on whether the FEI has direct access to the internet, is only on a private network or is offline.

The final component is the Analytics Engine 300. The Analytics Engine 300 interfaces with the Data Cloud to retrieve Prospect Data 210 and places one or more fields into extracted Prospect Data 320 and Property Information 220 in order to run one or more reports or perform analysis of the information 210, 220 for the purpose of business optimization, planning and investment decisions and related analytics. In the preferred embodiment, Analytics Engine 300 would also provide a means for determining whether a given prospect had elected to apply for a lease or was otherwise moving in. The Analytics Engine would also include business information 320 regarding local businesses in the vicinity of the property or businesses that provide goods or services to residents in the area and could also supplement Prospect Data 210 by retrieving information concerning businesses that the prospect may have frequented and enjoyed in the past (such reviews the prospect may have submitted such as in a Yelp® profile) or even friends or acquaintances that may live nearby (such as via Facebook® or LinkedIn® relationships). The combination of extracted Prospect Data 310 and local business information 320 would then permit the Analytics Engine 300 to transmit information to a soon to be lessee, renter or buyer regarding businesses 320 in their neighborhood that they would want to use, services that they may need to activate or deal that they could be offered prior to in connection with enticing the prospect, in conjunction with such as restaurant deals that may bring them back out to the neighborhood, or immediately following a move such as local grocery stores or moving services.

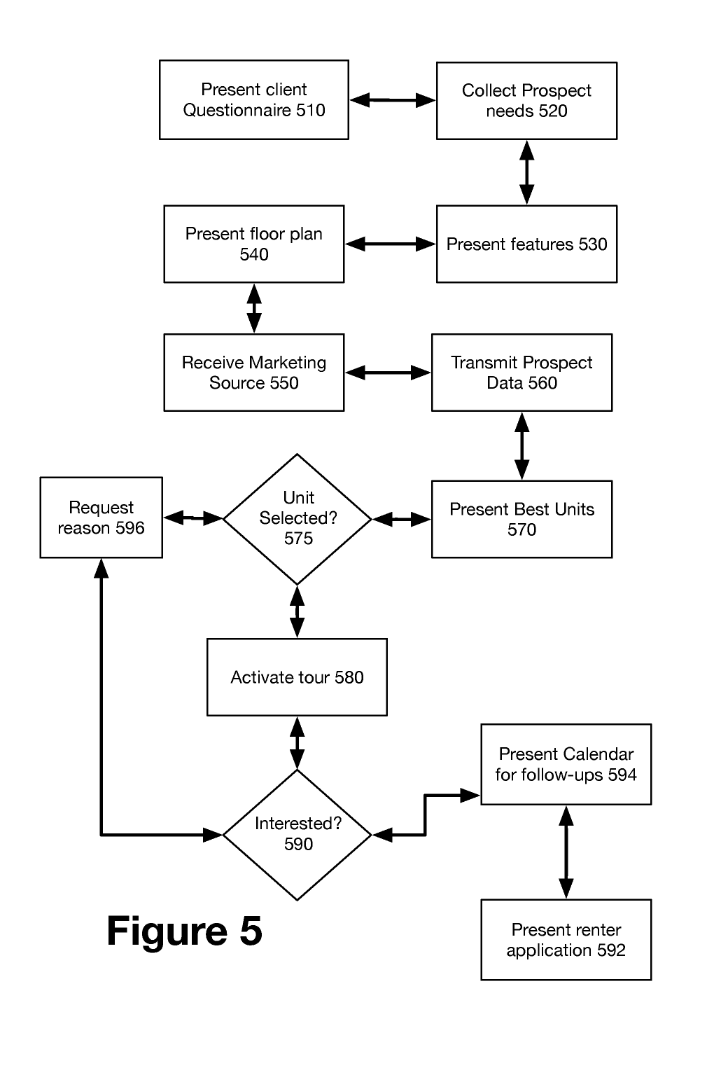

Referring now to FIG. 5, a flowchart illustrates the method of using the present invention to interview a prospect. In the disclosed embodiment, the process is implemented by a leasing agent during the initial interview/intake of a prospective resident. Alternatively, the FEI 100 could be used directly by the prospect as a sort of “self-help” questionnaire. In the preferred embodiment, the process begins 500 by completing 510 the client questionnaire. This includes basic contact information such as name, address, license number, cell phone, and other personally identifiable information. This is entered into the system using the FEI 100. This could further include social media accounts such as Facebook®, twitter®, LinkedIn® and similar social sites.

Next, information is acquired 520 concerning the needs of the renter such as rooms, whether they have pets, and their move in date. Were these on a standard online search, such criteria would be used to limit available units and present the resident with a narrow selection of possible choices or just indicate that no such units are available. In the present invention, however, this information is not revealed to the leasing agent OR the prospect. This is because, through experimentation, the present invented method anticipates that a prospect would have more desire for a unit with different parameters (such as more or less rooms) if other preferences were first introduced. As a result, the next step 530 is to request that the prospect select (such as by ordering) or provide their top three features. This might include features such as hardwood floors, number of bathrooms, washer and dryer in unit, or other features or amenities of an apartment for lease (or, in the case of houses, houses for sale).

It is important to note that these features could either be based on a generic list of common features or could instead be based on features of units or property that is actually available. In that regard, by picking among “desirable” qualities of available units, the prospect is directing positive attention and placing value on the features of the available inventory. By taking this affirming approach, the prospect is far more likely to have interest in available apartments even if they may lack other amenities that they would normally want or request.

In the next step 540, the prospect is given an opportunity to pick among his/her preferred floor plans. Once again, the focus is not on selecting a unit for the prospect or eliminating choices, as much as permitting positive affirmation for their preferred floor plans. These would preferably include 2D maps of the various floor plans and, if desired, could also include displaying media 130 such as 3D or “virtual tours” of the apartments.

Once the prospect's preferences, features and information have been collected via the FEI 100, the prospect enters 550 the marketing source that brought them to speak to the leasing agent or otherwise have interest in the property. For example, the source could have been a newspaper, a banner ad, a sign, or any number of other sources for referral.

Once this data has been fully collected (or from time to time throughout the term of data entry) the PEI 100 communicates 560 with the Data Cloud 200 to store the information and retrieve one or more properties that are most closely aligned with the prospect's stated preferences and desires. Property Information 120 about each of those available units is then presented 570 to the prospect. Once again, via the FEI, the prospect can interact with available unit information including media 130, 230 on those units and any other information that might be deemed relevant. In step 575, the prospect is asked to select a unit. If the prospect does not select a unit, then the prospect or leasing agent is solicited to provide a reason in step 596. In one embodiment, if the prospect or leasing agent selects a unit the FEI activates 580 the tour mode which could give directions on how to get to an open unit to view it directly. This could include a brief map on how to get to the unit along with instructions on how to unlock the unit, for example. In the case of a tour by a leasing agent, activating 580 a tour might involve collecting a scan or information from a valid photo ID as is often required for safety purposes. In one embodiment, the FEI could further communicate 580 to the Data Cloud 200 that is in communication with one or more electronic door locks on the unit (not shown) that permit it to be open and make the unit available for a short window of time following completion of the prospect questionnaire. Further information about the unit could be provided 585 in real time during these virtual tours including showing information such as “walkability scores,” local eateries, theaters and other points of interest much like one might experience with an audio tour at a museum.

Finally, depending on the level of interest by the prospect, the prospect or leasing indicates 590 to summarize their interest and fit for the available units. If there is interest, the prospect or agent could enter 592 preliminary application data to determine if the prospect meets financial, credit-worthiness and other qualifications. The leasing agent could also schedule 594 one or more follow-ups, such as phone calls or emails that will happen after the prospect leaves. Finally, in the event that the prospect is not interested, the basis for the lack of interest could be entered 596 for future marketing and improvement efforts.

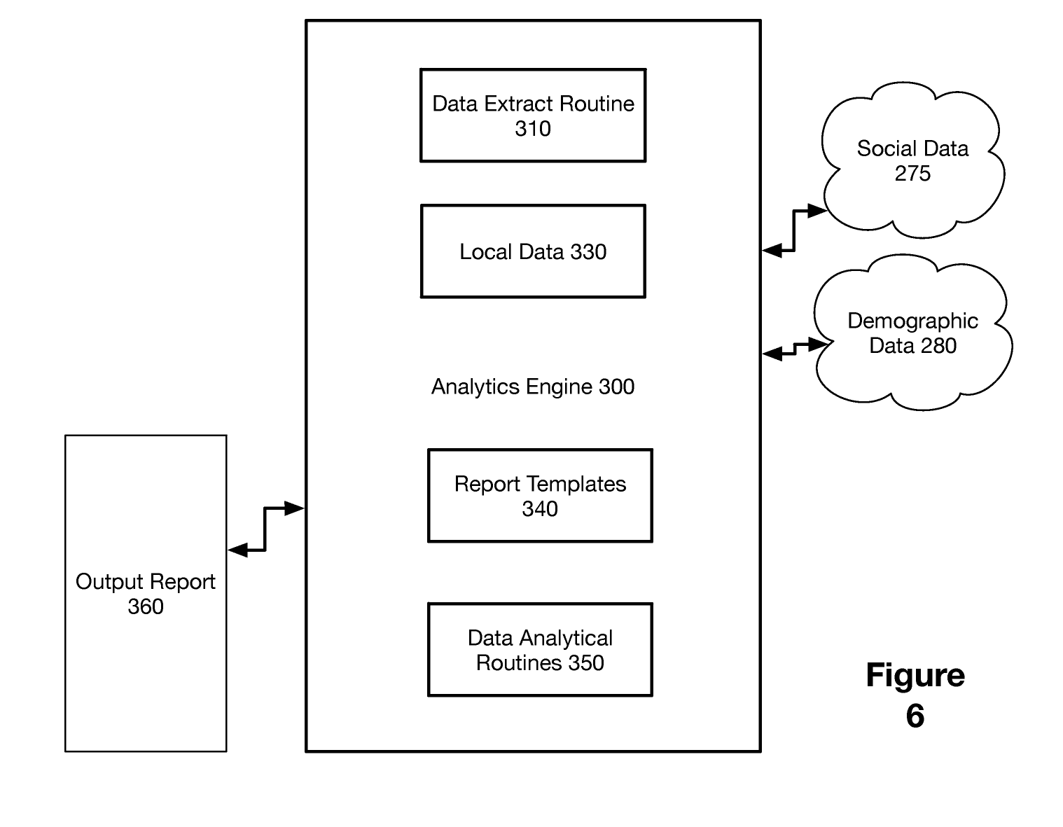

Referring now to FIG. 6, a block diagram illustrating the components and inputs/outputs of the Reporting Engine 300 is shown. The Reporting Engine 300 first begins operation by extracting one or more fields of data using the Data Extraction routine 310. The Data Extraction routine 310 may be comprised of any number of data retrieval functions including APIs (application programming interfaces) for third party data networks such as Social Networks 320, Third Party Data Services 330 or for local data extraction from a database in the Data Cloud 200 such as SQL server or other database calls. The Data Extraction Routine 310 could be configured to automatically retrieve one or more fields of data on a schedule (such as daily, weekly or monthly) or could instead be configured to retrieve data only upon user activation of one or more Report templates 340 that, when activated in conjunction with the Data Extract 310 and analytical routines 350 can create an output report 360. Furthermore, the Data Extraction Routine 310 can be configured to both link any relevant data from various sources (such as linking personal data with social data 275 or demographic data 280 for a given record) and can further include data cleaning or scrubbing functions that would remove redundant, inaccurate or irrelevant data.

The Reporting Engine 300 further includes a Data Analysis Routine 350. The Data Analysis Routine 350 applies one or more statistics or data analytics models to the data in order to create one or more Reports. Common data analytics models include descriptive statistics, exploratory data analysis (EDA), and confirmatory data analysis (CDA). EDA focuses on discovering new features in the data and CDA on confirming or falsifying existing hypotheses. Predictive analytics focuses on application of statistical or structural models for predictive forecasting or classification. Such models could help predict (based on local demographics—such as age, number of kids, pets, marital status, etc.) the most likely “features” that residents in that geographical location would desire. Data Analysis Routine 350 could further perform text analytics such as statistical, linguistic, and structural techniques to extract and classify information from textual sources such as online product or apartment reviews, local “buzz ” on social media websites in the geographical area of the apartment unit, or other types of unstructured data. Additional Data Analysis Routine(s) 350 could use the imported data to identify likely merchants or vendors nearby that might interest the prospect (or current) resident and could use contact information to offer special deals, coupons (such as Groupon®), and other “introductory” offers to prospects that decide to rent one or more units from a leasing agent or building owner.

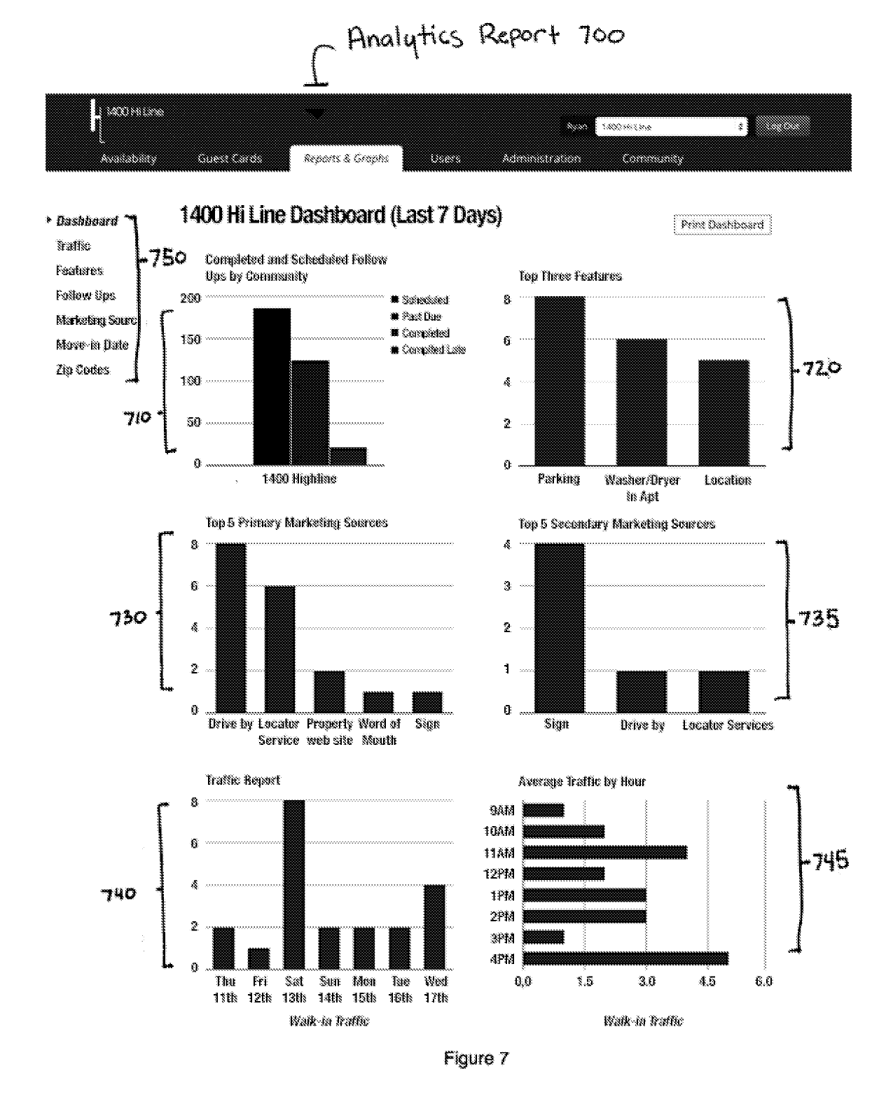

Referring now to FIG. 7, a sample analytics report 700 is shown. In this sample screenshot, a leasing agency or owner is provided with a real-time report setting forth recent information collected from prospects. In this instance, the report further includes a list of completed and scheduled follow-ups 710, a bar graph 720 showing what features were most commonly selected by those prospects along with the primary and secondary Marketing Sources 730, 735 that drove the most traffic to the location. Traffic reports 740 are also provided disclose traffic by day or by hour 745.In addition to graphs 710, 720, 730, the report can also include “deeper dive” links 750 that would permit a deeper drill down into any one category of informatics or reporting. Obviously, there are any number of unique configurations and extracts that can be reliably developed using the vast and multi-faceted data and methodologies enabled by the present invention. The present invention provides a powerful way to not only digitize and improve data collected by implementing an easy to use and intuitive FEI via leasing agents and prospects, but also provides a way to link that important “contact” data to social data via the Data Cloud 200 and ultimately, via the Reporting Engine 350. The Reporting Engine 350 integrates with third party data in such a way that leasing agencies, owners, local merchants and prospects can be given a comprehensive and complete picture of the market and opportunity landscape in real-time without undue cost or inconvenience.

Finally, Appendix A sets forth a number of sample images, embodiments and wireframes showing how the FEI can be configured for the purposes described herein. These are meant to be exemplary only. Although several preferred embodiments of this invention have been described in detail herein with reference to the accompanying drawings, it is to be understood that the invention is not limited to these precise embodiments, and that various changes and modifications may be effected therein by one skilled in the art without departing from the scope of spirit of the invention as defined in the appended claims.

I claim:

1) A method for enabling a property management firm to match a prospect to a property, or one or more units available for purchase or lease at such property, using a mobile computing device having a visual display and means for receiving input, comprising:
a. running a software application installed on the mobile device;
b. presenting one or more fields for entering contact information about the prospect;
c. responsive to submission of contact information, providing one or more fields for entering information about the prospect's family;
d. responsive to the receiving of information about the family, mapping the family information against a list of features commonly requested by prospects having that same family information that are available at such property;
e. retrieving one or more media files associated with the each feature identified in such mapping and displaying at least one of such media files on the computing device;
f. requesting that the prospect order three or more of the features identified based on their preferences;
g. providing a listing of each property or unit that includes one or more of the features identified by the prospect, listed in order of properties that include the highest ordered features;
h. retrieving the level of interest of the prospect in each listed property; and
i. submitting all of the information collected from the prospect to a database for storage.

2) The method of claim 1, further comprising the steps of:
a. retrieving information collected from the prospect stored in the database; and
b. generating a report that provides a visual summary of such information for the property management firm.

3) The method of claim 2, wherein the step of generating a report further includes generating a report for a property owner.

4) The method of claim 2, wherein the step of generating a report further includes generating a report for the prospect summarizing their preferred apartments.

5) The method of claim 1 wherein, responsive to receipt of a high level of interest in at least one property:
a. displaying directions for how to locate the property of interest; and
b. sending an electronic unlock code to the door of the property of interest for independent viewing by the prospect.

6) The method of claim 1 wherein, responsive to receipt of a high level of interest in at least one property, sending a calendar event to the property management firm to follow-up with such prospect.

7) The method of claim 1, responsive to receipt of a high level of interest in at least one property, further performing the steps of:
a. taking a picture of at least one state-issued identification; and
b. transmitting the picture of the identification to the database.

8) The method of claim 1, responsive to receipt of a high level of interest in at least one property, further performing the steps of:
a. retrieving a credit report on the prospect; and
b. using the retrieved credit information, determining if the prospect qualifies for the unit.

9) The method of claim 8, responsive to a determination that the prospect qualifies for the unit, sending at least a coupon or discount code to the prospect for a product or service provided by a business near the property.

10) The method of claim 1, wherein the step of retrieving one or more media files further includes retrieving electronic information associated with the schools that operate in the district where the property is located.

11) The method of claim 1, further comprising the step of retrieving one or more social network profiles associated with the prospect online and displaying any contacts or businesses with whom they have interacted that are located near the property.

12) The method of claim 11, wherein the step of retrieving a social profile includes retrieving a Yelp® profile and displaying any restaurants near the property that they have rated.

13) The method of claim 11, wherein the step of retrieving a social profile includes retrieving a Facebook® profile and displaying any friends that live or have checked in near the property.

14) A system for improving prospect identification and optimization using a mobile computing device having a visual display and means for receiving input, comprising:
a. A software application having a front-end interface that is displayed on such mobile computing device and includes one or more fields for entering information about the prospect or prospect preferences, and further includes communications that permit the transmission of data entered in one or more fields;
b. A two way communications network, logically connected to such front end interface, that transmits data between the front end interface and a data cloud;
c. A data cloud, connected to a two-way communications network, that transmits data to the front end interface in response to one or more requests and receives data entered into one or more fields of the front end interface and stores it for later retrieval; and
d. A reporting engine, in logical communications with the data cloud, that retrieves one or more fields of information from the data cloud and converts such retrieved information into one or more visual reports.

15) The system of claim 14, wherein the software application is an application running on the Apple® iOS operation system.

16) The system of claim 14, wherein the data cloud is comprised of at least one computer database and an application programming interface that permits access to electronic media stored on at least one website.
